(19) United States
(12) Patent Application Publication
(10) Pub. No.: US 2023/0103433 A1
(43) Pub. Date: Apr. 6, 2023

(54) SYSTEMS AND METHODS FOR ASSIGNING NON-OVERLAPPING BASE STATIONS TO TECHNICIANS FOR SERVICE

(71) Applicant: Verizon Patent and Licensing Inc., Basking Ridge, NJ (US)

(72) Inventors: Adithya UMAKANTH, Hyderabad (IN); Adithya vikram raj GAROJU, Hyderabad (IN); Sarathmohan N GANDHAM, Hyderabad (IN); Rahamathullah Babu NOORDEEN, Chennai (IN); Manojkumar SEKAR, TamilNadu (IN); Subhashini THANASEKARAN, Mudichur Chennai (IN); Abhitabh KUSHWAHA, Tampa, FL (US)

(73) Assignee: Verizon Patent and Licensing Inc., Basking Ridge, NJ (US)

(21) Appl. No.: 17/482,934

(22) Filed: Sep. 23, 2021

(51) Int. Cl. G06Q 10/06; G06Q 10/00; G06N 5/02; G01C 22/00

(52) U.S. Cl. CPC G06Q 10/063118; G01C 22/00; G06N 5/022; G06Q 10/20; G06Q 10/06312; G06Q 10/06313; G06Q 10/063114

(57) ABSTRACT

A device may receive technician data identifying home geographical locations of technicians and base station data identifying geographical locations of base stations, and may calculate travel distances and travel times between each of the technicians and each of the base stations based on the technician data, the base station data, and map data. The device may calculate technician distances between the technicians based on the technician data, and may determine the base stations to assign to each of the technicians, to generate groups of assigned base stations, based on a least cost model. The device may determine technician clusters based on processing the groups of assigned base stations with a clustering model, and may generate optimized technician assignments and modified groups of assigned base stations based on utilizing a balancing model. The device may perform one or more actions based on the modified groups of assigned base stations.

### BACKGROUND

A telecommunications provider may assign a technician (e.g., a field technician) to a group of base stations (e.g., cell towers). The technician may be responsible for installation, repair, and maintenance activities for the group of base stations throughout a time period (e.g., one year).

### BRIEF DESCRIPTION OF THE DRAWINGS

FIGS. 1A-1F are diagrams of an example associated with utilizing models to assign base stations to technicians for service.

FIG. 2 is a diagram illustrating an example of training and using a machine learning model in connection with assigning base stations to technicians for service.

FIG. 3 is a diagram of an example environment in which systems and/or methods described herein may be implemented.

FIG. 4 is a diagram of example components of one or more devices of FIG. 3.

FIG. 5 is a flowchart of an example process for utilizing models to assign base stations to technicians for service.

### DETAILED DESCRIPTION OF EXAMPLE EMBODIMENTS

The following detailed description of example implementations refers to the accompanying drawings. The same reference numbers in different drawings may identify the same or similar elements.

A technician may be assigned a defined average quantity of visits per base station and an anticipated duration of hours that the technician will spend at the base station per visit. An expense hour key performance indicator (KPI) may be determined based on a quantity of base stations assigned to the technician, a quantity of visits per base station, an expected quantity of hours to be spent at each base station per visit, a travel time (e.g., to and from) associated with each base station, and/or the like. Currently, groups of base stations are assigned to technicians by a manager or a director once a year and are updated based on daily technician availability. This results in non-optimal assignment of base stations to unavailable technicians, unnecessary dispatch of technicians to base stations already assigned to other technicians, incorrect assignment of base stations to technicians located further away from the base stations than other technicians. Thus, current techniques for assigning groups of base stations to technicians and managing the groups consumes computing resources (e.g., processing resources, memory resources, communication resources, and/or the like), networking resources, transportation resources, and/or other resources associated with nonoptimized assigning base stations to unavailable technicians, unnecessarily dispatching technicians to base stations already assigned to other technicians, incorrectly assigning base stations to technicians located further away from the base stations than other technicians, and/or the like.

Some implementations described herein provide an assignment system that utilizes models to assign base stations to technicians for service. For example, the assignment system may receive technician data identifying home geographical locations of technicians and base station data identifying geographical locations of base stations to be serviced by the technicians, and may calculate travel distances and travel times between each of the technicians and each of the base stations based on the technician data, the base station data, and map data identifying roads associated with geographical locations of the technicians and the base stations. The assignment system may calculate distances between the technicians based on the technicians' location data. The system may determine one or more base stations to assign to each of the technicians based on processing the travel distances, the travel times, and the technician distances using various modeling techniques. The assignment system may generate optimized technician assignments and groups of assigned base stations based on utilizing a balancing model. The assignment system may perform one or more actions based on the groups of assigned base stations.

In this way, the assignment system utilizes models to assign base stations to technicians for service. For example, the assignment system may optimize travel times of the technicians to assigned base stations, and may proportionally calculate total annual expense hours per technician, thereby reducing variations in the quantities of assignments (e.g., in expense hours) among the technicians. The assignment system may optimize the travel times and the expense hours associated with the technicians, and may balance workload assignments among the technicians or determine least possible variations among the expense hours. The assignment system may prevent the technicians from exceeding limits for a quantity of assigned base stations or expense hours by calculating optimized non-overlapping assignments of base stations technicians. Thus, implementations described herein may conserve computing resources, networking resources, transportation resources, and other resources that would have otherwise been consumed by nonoptimized assigning base stations to unavailable technicians, unnecessarily dispatching technicians to base stations already assigned to other technicians, incorrectly assigning base stations to technicians located further away from the base stations than other technicians, and/or the like.

Although implementations described herein relate to assigning base stations to technicians, the implementations described herein may also be utilized to optimally assign delivery-persons to a set of deliveries, to optimally assign various vehicles in a fleet management system for best job performance, to assign service calls to technicians for performing services at locations, and/or the like.

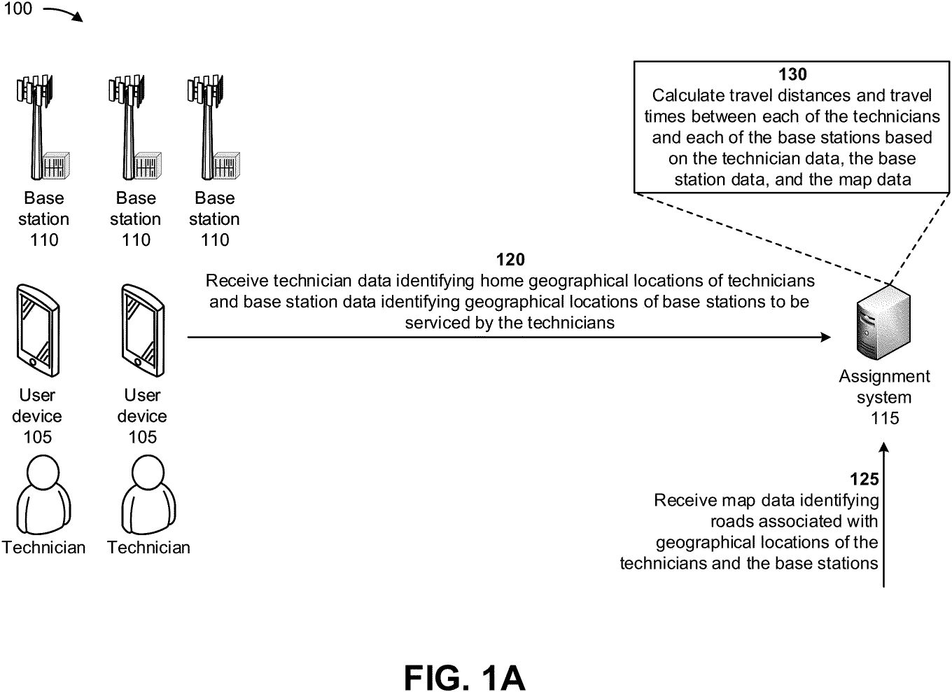

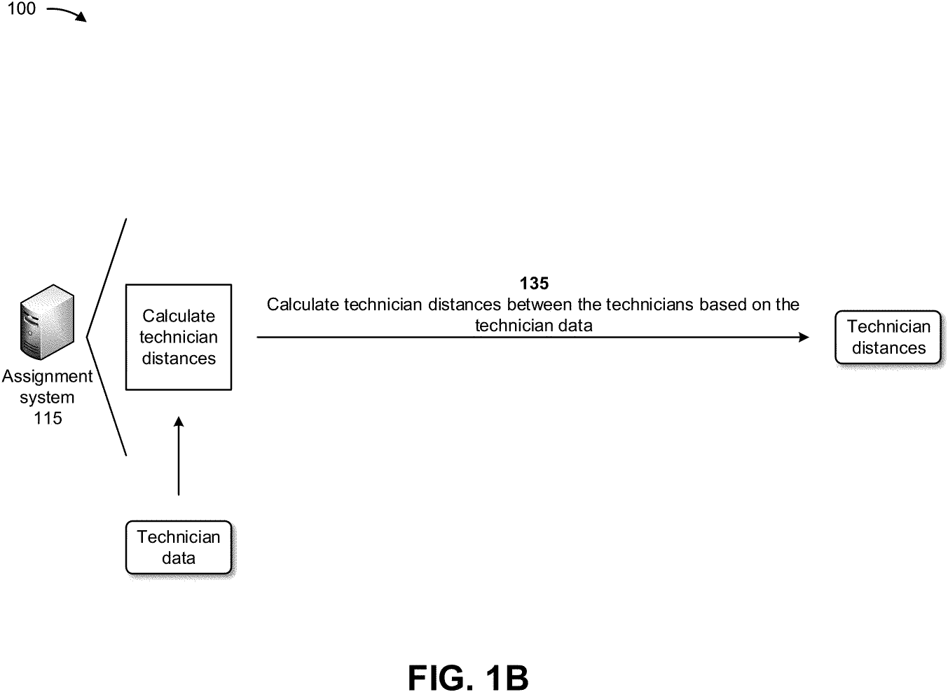

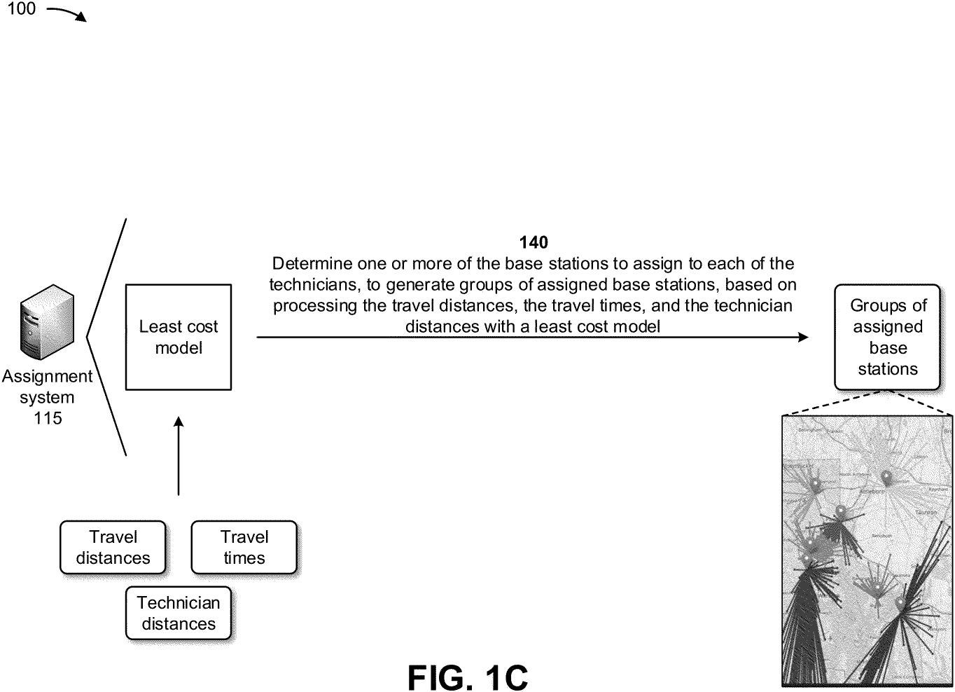

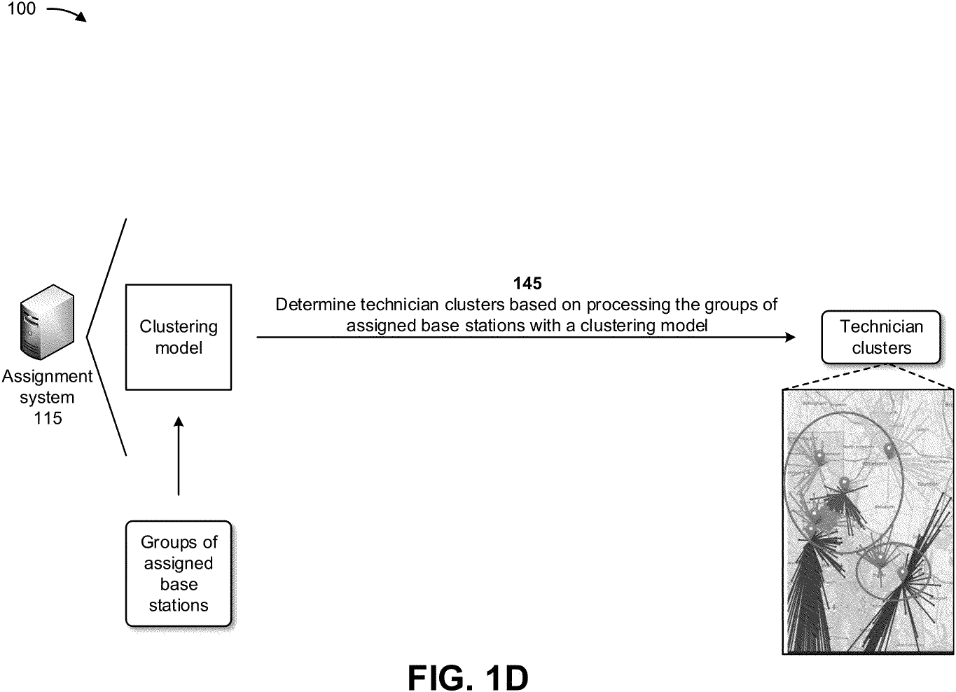

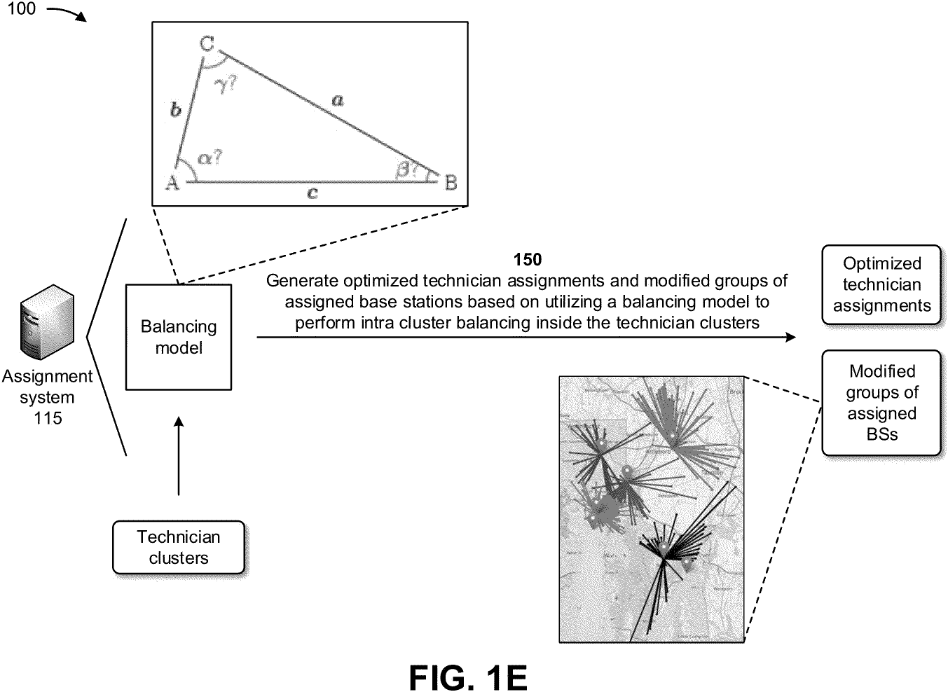

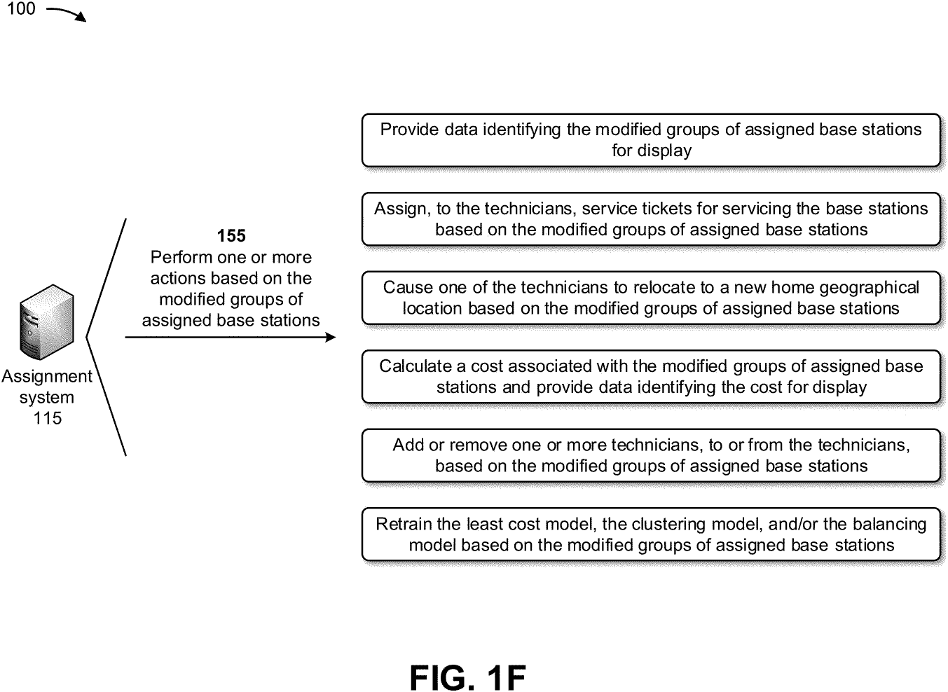

FIGS. 1A-1F are diagrams of an example 100 associated with utilizing models to assign base stations to technicians for service. As shown in FIGS. 1A-1F, example 100 includes user devices 105 (e.g., associated with corresponding technicians), base stations 110, and an assignment system 115. Further details of the user devices 105, the base stations 110, and the assignment system 115 are provided elsewhere herein.

As shown in FIG. 1A, and by reference number 120, the assignment system 115 may receive technician data identifying home geographical locations of the technicians and base station data identifying geographical locations of the base stations 110 to be serviced by the technicians. For example, the assignment system 115 may receive geographical addresses of homes of the technicians from an employee data structure (e.g., a database, a table, a list, and/or the like) and may calculate the home geographical locations (e.g., in latitudes and longitudes) of the technicians based on the geographical addresses of the homes of the technicians. The assignment system 115 may also monitor current locations of the technicians based on location coordinates (e.g., latitudes and longitudes) associated with the user devices 105. The assignment system 115 may receive the base station data identifying the geographical locations of the base stations 110 from a network management system associated with a network formed by the base stations. The geographical locations of the base stations 110 may include latitudes and longitudes associated with the base stations 110.

As further shown in FIG. 1A, and by reference number 125, the assignment system 115 may receive map data identifying roads associated with geographical locations of the technicians and the base stations 110. For example, the assignment system 115 may receive the map data from a map service, such as Google maps, MapQuest, and/or the like. The map data may identify roads in vicinities of the technicians and the base stations 110, roads associated with a geographical region (e.g., a state, a group of states, a country, and/or the like), and/or the like. The assignment system 115 may receive data identifying a quantity of visits required for each of the base stations 110 in the time period (e.g., one year, months, and/or the like), and may receive data identifying quantities of time spent by the technicians at the base stations 110 during the time period. The assignment system 115 may calculate an average quantity of visits to the base stations 110 and the average quantity of time spent by the technicians at the base stations 110 based on the quantities of time spent, and may store the data identifying the average quantity of visits and the average quantity of time in a data structure as historical data. The historical data may be utilized by a least cost model (e.g., described below) to perform expense hour calculations.

As further shown in FIG. 1A, and by reference number 130, the assignment system 115 may calculate travel distances and travel times between each of the technicians and each of the base stations 110 based on the technician data, the base station data, and the map data. For example, the assignment system 115 may identify, from the technician data, the base station data, and the map data, potential roads traveled by the technicians to the base stations 110, and may determine speed limits associated with the roads based on the map data. The assignment system 115 may calculate the travel distances and the travel times between each of the technicians and each of the base stations 110 based on the identified potential roads and the speed limits. In some implementations, the assignment system 115 may calculate the travel times between each of the technicians and each of the base stations 110 based on historical traffic conditions, historical travel times, and/or the like.

As shown in FIG. 1B, and by reference number 135, the assignment system 115 may calculate technician distances between the technicians based on the technician data. For example, the assignment system 115 may utilize the home geographical locations (e.g., latitudes and longitudes) of the technicians to calculate the technician distances. In some implementations, the assignment system 115 may identify, from the technician data and the map data, potential roads traveled by the technicians to other technicians, and may determine speed limits associated with the roads based on the map data. The assignment system 115 may calculate travel distances and travel times between each of the technicians based on the identified potential roads and the speed limits. In some implementations, the assignment system 115 may also calculate cost of travel associated with the potential roads (e.g., costs of tolls for bridges or tunnels, costs of tolls for highway utilization, costs associated with depreciation of vehicles of the technicians, fuel usage and cost, and/or the like).

As shown in FIG. 1C, and by reference number 140, the assignment system 115 may determine one or more of the base stations 110 to assign to each of the technicians, to generate groups of assigned base stations 110, based on processing the travel distances, the travel times, and the technician distances with a least cost model. The least cost model may include a model that utilizes traversal costs across a geographical area to measure a least-cost distance between locations as a function of both distances traveled and costs traversed. For example, the assignment system 115 may determine nearest or least cost base stations 110 associated with each of the technicians. In some examples, the system 115 may use a model such as a least cost model for this determination. The assignment system 115 may then assign the nearest or least cost base stations 110 to the corresponding technicians to generate the groups of assigned base stations 110.

In some implementations, the assignment system 115 may determine the least cost base stations 110 based on expense hours associated with traveling to and servicing the base stations 110 by the technicians. For example, the assignment system 115 may determine the expense hours according to the formula:

$${\sum }_{i = 1}^{n t h c e l l s i t e} \left(\left(t r a v e l t i m e \left[i\right] ∗ 2\right)\right) ∗ \left(q u a n t i t y o f v i s i t s \left[i\right]\right) + w o r k h o u r s \left[i\right]$$

where the travel time represents the travel times between each of the technicians and each of the base stations 110, the quantity of visits represents the historical average quantity of service visits to each of the base stations 110, and work hours represents the average quantity of time spent by the technicians at the base stations 110.

In some implementations, the assignment system 115 may determine the one or more of the base stations to assign to each of the technicians by calculating geographically nearest and least cost base stations 110, with respect to the home geographical locations of each of the technicians, based on the travel distances, the travel times, and the technician distances. The assignment system 115 may assign the geographically nearest and least cost base stations 110 to each of the technicians, and may generate the groups of assigned base stations 110 based on assigning the geographically nearest and least cost base stations 110 to each of the technicians. In some implementations, each group, of the groups of assigned base stations 110, is assigned to a corresponding one of the technicians.

As shown in FIG. 1D, and by reference number 145, the assignment system 115 may determine technician clusters based on processing the groups of assigned base stations 110 with a clustering model. In some implementations, the assignment system 115 may determine the technician clusters by identifying the next nearest technicians for each of the technicians based on the travel distances, the travel times, and the technician distances, and generating lists of next nearest technicians based on identifying next nearest technicians for each of the technicians. For example, for each technician, the clustering model may determine a next nearest (e.g., based on cost or distance) technician by recursively adding the next nearest technicians to a list. The clustering model may cease recursively adding to the list when the next nearest technician is a previous technician of the list. For example, if technician B is a next nearest technician for technician A, technician C is a next nearest technician for technician B, technician D is a next nearest technician for technician C, and technician C is a next nearest technician for technician D, then the clustering model may cease the recursion loop and generate technicians A, B, C, and D as a final list.

The assignment system 115 may form the technician clusters based on the lists of next nearest technicians by eliminating one or more next nearest technicians from one or more of the lists (e.g., subset lists) of next nearest technicians or by merging one or more of the lists of next nearest technicians (e.g., superset lists). For example, the assignment system 115 may create the list of technicians A, B, C, and D and may create another list of technicians Z, A, B, C, and D, where technician A is a next nearest technician for technician Z. In such an example, the assignment system 115 may merge the list of technicians A, B, C, and D and the other list of technicians Z, A, B, C, and D to form a technician cluster of technicians Z, A, B, C, and D.

As shown in FIG. 1E, and by reference number 150, the assignment system 115 may generate optimized technician assignments and modified groups of assigned base stations 110 based on utilizing a balancing model to perform intra cluster balancing inside the technician clusters. In some implementations, the assignment system 115 may generate the optimized technician assignments and the modified groups of assigned base stations 110 by utilizing the balancing model to perform intra cluster balancing inside the technician clusters to generate the optimized technician assignments, and generating the modified groups of assigned base stations based on the optimized technician assignments.

In some implementations, the assignment system 115 may generate the optimized technician assignments and the modified groups of assigned base stations 110 by reassigning one or more base stations 110 from one or more of the technicians to another one or more of the technicians based on workloads associated with the groups of assigned base stations 110, and generating the optimized technician assignments and the modified groups of assigned base stations based on reassigning one or more base stations from one or more of the technicians to another one or more of the technicians. For example, the balancing model may identify technicians with larger workloads and technicians with smaller workloads based on +/- three standard deviations (or interquartile range, IQR) (e.g., > Q3 + IQR and < Q2 - IQR) and based on not falling within minimum and maximum defined ranges internal to the technician clusters. For each technician with a smaller workload, the balancing model may reassign base stations 110 from a next nearest technician to the smaller workload technician. For each technician with a larger workload, the balancing model may reassign base stations 110 from the larger workload technician to a next nearest technician. Before the balancing model reassigns base stations 110 from one technician to another technician, the balancing model may determine that the following conditions are not satisfied: the base station 110 being reassigned is not the nearest one for the original assigned technician; and the base station 110 being reassigned, from another technician, disturbs a tightness of a technician clusters and causes overlapping path assignments to occur with the other technician.

The assignment system 115 may utilize a triangle-based model to determine whether overlapping path assignments occur. For example, triangle-based model may determine that base station C is to be reassigned from technician A to technician B because technician A is servicing more base stations 110 than technician B and based on distances between base station C and technicians A and B. For example, if base station C is located 0.5 miles away from technician A, the assignment system 115 may not consider reassigning base station C to technician B. However, if base station is 2.5 miles away from technician A and 3 miles away from technician B, then the assignment system 115 may select technician B. With reference to the triangle diagram shown in FIG. 1E, the assignment system 115 may convert geospatial latitude and longitude coordinates, associated with technician A, technician B, and base station C to Cartesian coordinates using formulas of the form:

$$\begin{matrix}x = R * c o s \left(l a t\right) * c o s \left(l o n\right) \\ y = R * c o s \left(l a t\right) * s i n \left(l o n\right)\end{matrix}$$

where R represents a radius of the Earth. The assignment system 115 may utilize Euclidean distances from technician B to base station C (as a), from base station C to technician A (as b), and from technician A to technician B (as c) to form the derived Cartesian coordinates. The assignment system 115 may apply the trigonometric formulas to derive an angle α(∟CAB), an angle β(∟ABC), and an angle γ(∟BCA):

$$\begin{matrix}α = a r c c o s \frac{{b}^{2} + {c}^{2} - {a}^{2}}{2 b c} , \\ β = a r c s o c \frac{{a}^{2} + {c}^{2} - {b}^{2}}{2 a c} , \\ γ = 180 ° - α - β .\end{matrix}$$

If the angle α is acute angle, then the assignment system 115 may reassign base station C from technician A to technician B. The assignment system 115 may utilize a similar process to push a reassigned base station 110 from one technician to another technician. The assignment system 115 may recursively perform the intra self-balancing loop, for each technician cluster, until there are no base stations 110 to pull or push (e.g., reassign) or all assignments per technician are below a predetermined standard deviation or a minimum or maximum variation.

In some implementations, the assignment system 115 may generate further optimized technician assignments and further modified groups of assigned base stations 110 based on utilizing the balancing model to perform inter cluster balancing for the optimized technician assignments.

As shown in FIG. 1F, and by reference number 155, the assignment system 115 may perform one or more actions based on the modified groups of assigned base stations 110. In some implementations, the one or more actions include the assignment system 115 providing data identifying the modified groups of assigned base stations 110 for display. For example, the assignment system 115 may provide the data identifying the modified groups of assigned base stations 110 for display to the user devices 105 so that the technicians may perform service on the modified groups of assigned base stations 110 (e.g., according to a schedule). In this way, the assignment system 115 may conserve computing resources, networking resources, transportation resources, and other resources that would have otherwise been consumed by nonoptimized assigning base stations 110 to unavailable technicians, unnecessarily dispatching technicians to base stations 110 already assigned to other technicians, incorrectly assigning base stations 110 to technicians located further away from the base stations 110 than other technicians, and/or the like.

In some implementations, the one or more actions include the assignment system 115 assigning, to the technicians, service tickets for servicing the base stations 110 based on the modified groups of assigned base stations 110. For example, the assignment system 115 may determine a service schedule for the technicians based on the modified groups of assigned base stations 110, and may generate service tickets for the technicians in accordance with the service schedule. The technicians may utilize the service tickets to perform service on the base stations 110. In this way, the assignment system 115 may conserve computing resources, networking resources, transportation resources, and other resources that would have otherwise been consumed by unnecessarily dispatching technicians to base stations 110 already assigned to other technicians, incorrectly assigning base stations 110 to technicians located further away from the base stations 110 than other technicians, and/or the like.

In some implementations, the one or more actions include the assignment system 115 causing one of the technicians to relocate to a new home geographical location based on the modified groups of assigned base stations 110. For example, the assignment system 115 may determine, based on the modified groups of assigned base stations 110, that a technician may better serve a group of assigned base stations 110 if the technician were to relocate to a new home (e.g., closer to the group of assigned base stations 110). The assignment system 115 may provide the determination to systems responsible for arranging relocation of the technician. In this way, the assignment system 115 may conserve computing resources, networking resources, transportation resources, and other resources that would have otherwise been consumed by incorrectly assigning base stations 110 to technicians located further away from the base stations 110 than other technicians, and/or the like.

In some implementations, the one or more actions include the assignment system 115 calculating a cost associated with the modified groups of assigned base stations 110 and providing data identifying the cost for display. For example, the assignment system 115 may provide the data identifying the cost for display to financial personnel so that financial resources may be allocated to perform service on the base stations 110 in accordance with the modified group of assigned base stations 110. In this way, the assignment system 115 may conserve computing resources, networking resources, transportation resources, and other resources that would have otherwise been consumed by nonoptimized assigning base stations 110 to unavailable technicians, incorrectly assigning base stations 110 to technicians located further away from the base stations 110 than other technicians, and/or the like.

In some implementations, the one or more actions include the assignment system 115 adding or removing one or more technicians, to or from the technicians, based on the modified groups of assigned base stations 110. For example, the assignment system 115 may determine that a new technician (e.g., near a particular location) should be added to the technicians based on the modified groups of assigned base stations 110. The assignment system 115 may provide the determination to systems responsible for securing additional personnel to obtain additional technicians. In this way, the assignment system 115 may conserve computing resources, networking resources, transportation resources, and other resources that would have otherwise been consumed by incorrectly assigning base stations 110 to technicians located further away from the base stations 110 than other technicians, and/or the like.

In some implementations, the one or more actions include the assignment system 115 retraining one or more of the least cost model, the clustering model, and/or the balancing model based on the modified groups of base stations. The assignment system 115 may utilize the modified groups of base stations as additional training data for retraining the one or more of the least cost model, the clustering model, and/or the balancing model, thereby increasing the quantity of training data available for training the one or more of the least cost model, the clustering model, and/or the balancing model. Accordingly, the assignment system 115 may conserve computing resources associated with identifying, obtaining, and/or generating historical data for training the one or more of the least cost model, the clustering model, and/or the balancing model relative to other systems for identifying, obtaining, and/or generating historical data for training machine learning models.

In this way, the assignment system 115 utilizes models to assign base stations 110 to technicians for service. For example, the assignment system 115 may optimize travel times of the technicians to assigned base stations 110, and may proportionally calculate total annual expense hours per technician, thereby reducing variations in the quantities of assignments (e.g., in expense hours) among the technicians. The assignment system 115 may optimize the travel times and the expense hours associated with the technicians, and may balance workload assignments among the technicians or determine least possible variations among the expense hours. The assignment system 115 may prevent the technicians from exceeding limits for a quantity of assigned base stations or expense hours by calculating optimized non-overlapping assignments of base stations 110 of technicians. Thus, implementations described herein may conserve computing resources, networking resources, transportation resources, and other resources that would have otherwise been consumed by nonoptimized assigning base stations 110 to unavailable technicians, unnecessarily dispatching technicians to base stations 110 already assigned to other technicians, incorrectly assigning base stations 110 to technicians located further away from the base stations 110 than other technicians, and/or the like.

As indicated above, FIGS. 1A-1F are provided as an example. Other examples may differ from what is described with regard to FIGS. 1A-1F. The number and arrangement of devices shown in FIGS. 1A-1F are provided as an example. In practice, there may be additional devices, fewer devices, different devices, or differently arranged devices than those shown in FIGS. 1A-1F. Furthermore, two or more devices shown in FIGS. 1A-1F may be implemented within a single device, or a single device shown in FIGS. 1A-1F may be implemented as multiple, distributed devices. Additionally, or alternatively, a set of devices (e.g., one or more devices) shown in FIGS. 1A-1F may perform one or more functions described as being performed by another set of devices shown in FIGS. 1A-1F.

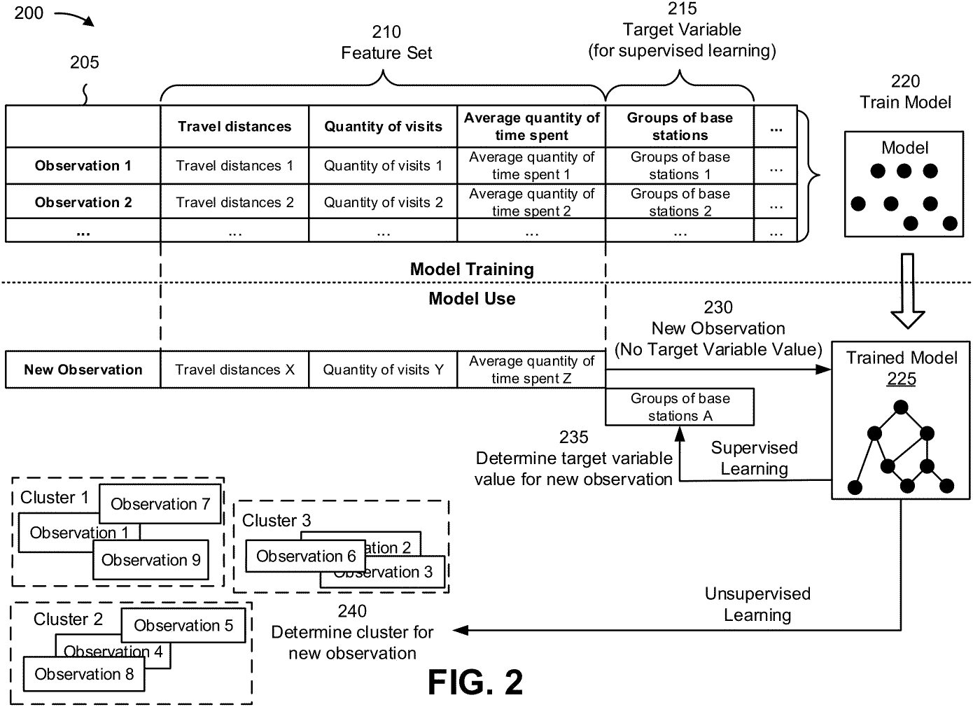

FIG. 2 is a diagram illustrating an example 200 of training and using a machine learning model in connection with assigning base stations to technicians for service. The machine learning model training and usage described herein may be performed using a machine learning system. The machine learning system may include or may be included in a computing device, a server, a cloud computing environment, and/or the like, such as the assignment system 115 described in more detail elsewhere herein.

As shown by reference number 205, a machine learning model may be trained using a set of observations. The set of observations may be obtained from historical data, such as data gathered during one or more processes described herein. In some implementations, the machine learning system may receive the set of observations (e.g., as input) from the assignment system 115, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the assignment system 115. For example, the machine learning system may identify a feature set (e.g., one or more features and/or feature values) by extracting the feature set from structured data, by performing natural language processing to extract the feature set from unstructured data, by receiving input from an operator, and/or the like.

As an example, a feature set for a set of observations may include a first feature of travel distances, a second feature of quantity of visits, a third feature of average quantity of time spent, and so on. As shown, for a first observation, the first feature may have a value of travel distances 1, the second feature may have a value of quantity of visits 1, the third feature may have a value of average quantity of time spent 1, and so on. These features and feature values are provided as examples and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiple classes, classifications, labels, and/or the like), may represent a variable having a Boolean value, and/or the like. A target variable may be associated with a target variable value, and a target variable value may be specific to an observation. In example 200, the target variable is groups of base stations, which has a value of groups of base stations 1 for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, and/or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of travel distances X, a second feature of quantity of visits Y, a third feature of average quantity of time spent Z, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs, information that indicates a degree of similarity between the new observation and one or more other observations, and/or the like, such as when unsupervised learning is employed.

As an example, the trained machine learning model 225 may predict a value of groups of base stations A for the target variable of the groups of base stations for the new observation, as shown by reference number 235. Based on this prediction, the machine learning system may provide a first recommendation, may provide output for determination of a first recommendation, may perform a first automated action, may cause a first automated action to be performed (e.g., by instructing another device to perform the automated action), and/or the like.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., a travel distances cluster), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., a quantity of visits cluster), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification, categorization, and/or the like), may be based on whether a target variable value satisfies one or more thresholds (e.g., whether the target variable value is greater than a threshold, is less than a threshold, is equal to a threshold, falls within a range of threshold values, and/or the like), may be based on a cluster in which the new observation is classified, and/or the like.

In this way, the machine learning system may apply a rigorous and automated process to assign base stations to technicians for service. The machine learning system enables recognition and/or identification of tens, hundreds, thousands, or millions of features and/or feature values for tens, hundreds, thousands, or millions of observations, thereby increasing accuracy and consistency and reducing delay associated with assigning base stations to technicians for service relative to requiring computing resources to be allocated for tens, hundreds, or thousands of operators to manually assigning base stations to technicians for service.

As indicated above, FIG. 2 is provided as an example. Other examples may differ from what is described in connection with FIG. 2.

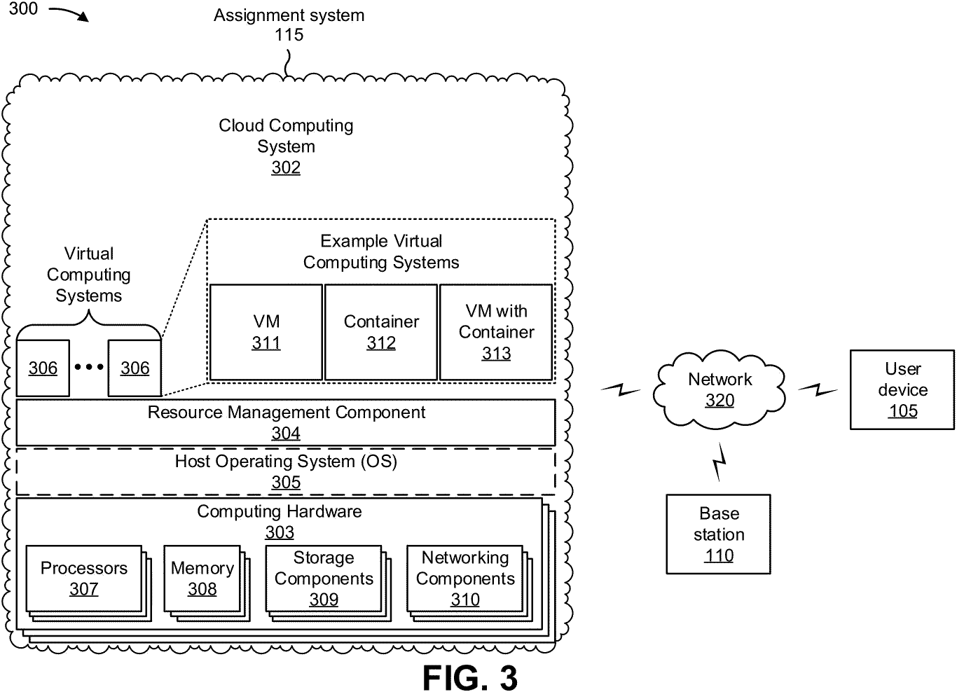

FIG. 3 is a diagram of an example environment 300 in which systems and/or methods described herein may be implemented. As shown in FIG. 3, environment 300 may include the assignment system 115, which may include one or more elements of and/or may execute within a cloud computing system 302. The cloud computing system 302 may include one or more elements 303-313, as described in more detail below. As further shown in FIG. 3, environment 300 may include the user device 105, the base station 110, and/or a network 320. Devices and/or elements of environment 300 may interconnect via wired connections and/or wireless connections.

The user device 105 includes one or more devices capable of receiving, generating, storing, processing, and/or providing information, as described elsewhere herein. The user device 105 may include a communication device and/or a computing device. For example, the user device 105 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The base station 110 includes one or more devices capable of transferring traffic, such as audio, video, text, and/or other traffic, destined for and/or received from the user device 105. In some implementations, the base station 110 may include an eNodeB (eNB) associated with a long term evolution (LTE) network that receives traffic from and/or sends traffic to the network 320. Additionally, or alternatively, the base station 110 may include a gNodeB (gNB) associated with a fifth generation (5G) radio access network (RAN) that receives traffic from and/or sends traffic to the network 320. The base station 110 may send traffic to and/or receive traffic from the user device 105 via an air interface. In some implementations, the base station 110 may include a small cell base station, such as a base station of a microcell, a picocell, or a femtocell.

The cloud computing system 302 includes computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

Computing hardware 303 includes hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using computing hardware 303. As shown, a virtual computing system 306 may include a virtual machine 311, a container 312, or a hybrid environment 313 that includes a virtual machine and a container, among other examples. A virtual computing system 306 may execute one or more applications using a file system that includes binary files, software libraries, and/or other resources required to execute applications on a guest operating system (e.g., within the virtual computing system 306) or the host operating system 305.

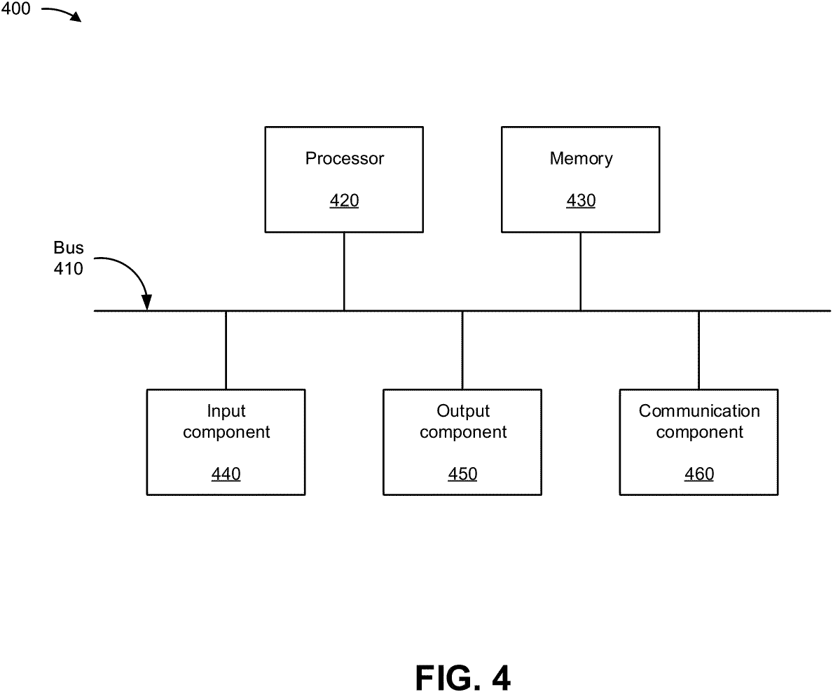

Although the assignment system 115 may include one or more elements 303-313 of the cloud computing system 302, may execute within the cloud computing system 302, and/or may be hosted within the cloud computing system 302, in some implementations, the assignment system 115 may not be cloud-based (e.g., may be implemented outside of a cloud computing system) or may be partially cloud-based. For example, the assignment system 115 may include one or more devices that are not part of the cloud computing system 302, such as the device 400 of FIG. 4, which may include a standalone server or another type of computing device. The assignment system 115 may perform one or more operations and/or processes described in more detail elsewhere herein.

The network 320 includes one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400, which may correspond to the user device 105, the base station 110, and/or the assignment system 115. In some implementations, the user device 105, the base station 110, and/or the assignment system 115 may include one or more devices 400 and/or one or more components of the device 400. As shown in FIG. 4, the device 400 may include a bus 410, a processor 420, a memory 430, an input component 440, an output component 450, and a communication component 460.

The bus 410 includes a component that enables wired and/or wireless communication among the components of the device 400. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform a function. The memory 430 includes a random-access memory, a read only memory, and/or another type of memory (e.g., a flash memory, a magnetic memory, and/or an optical memory).

The input component 440 enables the device 400 to receive input, such as user input and/or sensed inputs. For example, the input component 440 may include a touch screen, a keyboard, a keypad, a mouse, a button, a microphone, a switch, a sensor, a global positioning system component, an accelerometer, a gyroscope, and/or an actuator. The output component 450 enables the device 400 to provide output, such as via a display, a speaker, and/or one or more light-emitting diodes. The communication component 460 enables the device 400 to communicate with other devices, such as via a wired connection and/or a wireless connection. For example, the communication component 460 may include a receiver, a transmitter, a transceiver, a modem, a network interface card, and/or an antenna.

The device 400 may perform one or more processes described herein. For example, a non-transitory computer-readable medium (e.g., the memory 430) may store a set of instructions (e.g., one or more instructions, code, software code, and/or program code) for execution by the processor 420. The processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

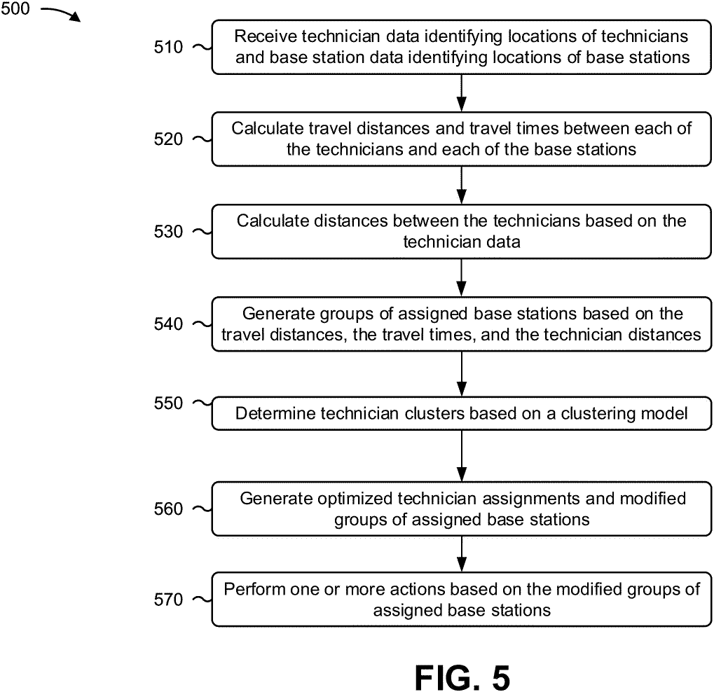

FIG. 5 is a flowchart of an example process 500 for utilizing models to assign base stations to technicians for service. In some implementations, one or more process blocks of FIG. 5 may be performed by a device (e.g., the assignment system 115). In some implementations, one or more process blocks of FIG. 5 may be performed by another device or a group of devices separate from or including the device, such as a user device (e.g., the user device 105). Additionally, or alternatively, one or more process blocks of FIG. 5 may be performed by one or more components of the device 400, such as the processor 420, the memory 430, the input component 440, the output component 450, and/or the communication component 460.

As shown in FIG. 5, process 500 may include receiving technician data identifying home geographical locations of technicians and base station data identifying geographical locations of base stations to be serviced by the technicians (block 510). For example, the device may receive technician data identifying home geographical locations of technicians and base station data identifying geographical locations of base stations to be serviced by the technicians, as described above.

As further shown in FIG. 5, process 500 may include calculating travel distances and travel times between each of the technicians and each of the base stations based on the technician data, the base station data, and map data identifying roads associated with geographical locations of the technicians and the base stations (block 520). For example, the device may calculate travel distances and travel times between each of the technicians and each of the base stations based on the technician data, the base station data, and map data identifying roads associated with geographical locations of the technicians and the base stations, as described above.

As further shown in FIG. 5, process 500 may include calculating technician distances between the technicians based on the technician data (block 530). For example, the device may calculate technician distances between the technicians based on the technician data, as described above.

As further shown in FIG. 5, process 500 may include determining one or more of the base stations to assign to each of the technicians, to generate groups of assigned base stations, based on processing the travel distances, the travel times, and the technician distances with a least cost model (block 540). For example, the device may determine one or more of the base stations to assign to each of the technicians, to generate groups of assigned base stations, based on processing the travel distances, the travel times, and the technician distances with a least cost model, as described above. In some implementations, determining the one or more of the base stations to assign to each of the technicians includes calculating geographically nearest and least cost base stations, with respect to the home geographical locations of each of the technicians, based on the travel distances, the travel times, and the technician distances, and assigning the geographically nearest and least cost base stations to each of the technicians to generate the groups of assigned base stations, wherein each group, of the groups of assigned base stations, is assigned to a corresponding one of the technicians.

As further shown in FIG. 5, process 500 may include determining technician clusters based on processing the groups of assigned base stations with a clustering model (block 550). For example, the device may determine technician clusters based on processing the groups of assigned base stations with a clustering model, as described above. In some implementations, determining the technician clusters includes identifying next nearest technicians for each of the technicians based on the travel distances, the travel times, and the technician distances, generating lists of next nearest technicians based on identifying next nearest technicians for each of the technicians, and forming the technician clusters based on the lists of next nearest technicians. In some implementations, forming the technician clusters based on the lists of next nearest technicians includes one or more of eliminating one or more next nearest technicians from one or more of the lists of next nearest technicians, or merging one or more of the lists of next nearest technicians.

As further shown in FIG. 5, process 500 may include generating optimized technician assignments and modified groups of assigned base stations based on performing intra cluster balancing inside the technician clusters (block 560). For example, the device may generate optimized technician assignments and modified groups of assigned base stations based on performing intra cluster balancing inside the technician clusters, as described above. In some implementations, generating the optimized technician assignments and the modified groups of assigned base stations includes utilizing a balancing model to perform intra cluster balancing inside the technician clusters to generate the optimized technician assignments, and generating the modified groups of assigned base stations based on the optimized technician assignments.

In some implementations, generating the optimized technician assignments and the modified groups of assigned base stations includes reassigning one or more base stations from one or more of the technicians to another one or more of the technicians based on workloads associated with the groups of assigned base stations, and generating the optimized technician assignments and the modified groups of assigned base stations based on reassigning one or more base stations from one or more of the technicians to another one or more of the technicians. In some implementations, a balancing model performs intra cluster balancing inside the technician clusters by utilizing Euclidean distances and trigonometric models to generate the optimized technician assignments and the modified groups of assigned base stations.

As further shown in FIG. 5, process 500 may include performing one or more actions based on the modified groups of assigned base stations (block 570). For example, the device may perform one or more actions based on the modified groups of assigned base stations, as described above. In some implementations, performing the one or more actions includes one or more of providing data identifying the modified groups of assigned base stations for display, or retraining one or more of the least cost model, the clustering model, or a balancing model based on the modified groups of assigned base stations. In some implementations, performing the one or more actions includes assigning, to the technicians, service tickets for servicing the base stations based on the modified groups of assigned base stations, and monitoring performance of the service tickets.

In some implementations, performing the one or more actions based on the modified groups of assigned base stations includes one or more of causing one of the technicians to relocate to a new home geographical location based on the modified groups of assigned base stations, or adding or remove one or more technicians, to or from the technicians, based on the modified groups of assigned base stations. In some implementations, performing the one or more actions based on the modified groups of assigned base stations includes calculating a cost associated with the modified groups of assigned base stations, and providing data identifying the cost for display.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

In some implementations, process 500 includes generating further optimized technician assignments and further modified groups of assigned base stations based on performing inter cluster balancing of the optimized technician assignments.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, technician data identifying home geographical locations of technicians and base station data identifying geographical locations of base stations to be serviced by the technicians;
calculating, by the device, travel distances and travel times between each of the technicians and each of the base stations based on the technician data, the base station data, and map data identifying roads associated with geographical locations of the technicians and the base stations;
calculating, by the device, technician distances between the technicians based on the technician data;
determining, by the device, one or more of the base stations to assign to each of the technicians, to generate groups of assigned base stations, based on processing the travel distances, the travel times, and the technician distances with a least cost model;
determining, by the device, technician clusters based on processing the groups of assigned base stations with a clustering model;
generating, by the device, optimized technician assignments and modified groups of assigned base stations based on performing intra cluster balancing inside the technician clusters; and
performing, by the device, one or more actions based on the modified groups of assigned base stations.

2. The method of claim 1, wherein performing the one or more actions comprises one or more of:
providing data identifying the modified groups of assigned base stations for display; or
retraining one or more of the least cost model, the clustering model, or a balancing model based on the modified groups of assigned base stations.

3. The method of claim 1, wherein determining the one or more of the base stations to assign to each of the technicians comprises:
calculating geographically nearest and least cost base stations, with respect to the home geographical locations of each of the technicians, based on the travel distances, the travel times, and the technician distances; and
assigning the geographically nearest and least cost base stations to each of the technicians to generate the groups of assigned base stations,
wherein each group, of the groups of assigned base stations, is assigned to a corresponding one of the technicians.

4. The method of claim 1, wherein determining the technician clusters comprises:
identifying next nearest technicians for each of the technicians based on the travel distances, the travel times, and the technician distances;
generating lists of next nearest technicians based on identifying next nearest technicians for each of the technicians; and
forming the technician clusters based on the lists of next nearest technicians.

5. The method of claim 4, wherein forming the technician clusters based on the lists of next nearest technicians comprises one or more of:
eliminating one or more next nearest technicians from one or more of the lists of next nearest technicians; or
merging one or more of the lists of next nearest technicians.

6. The method of claim 1, wherein generating the optimized technician assignments and the modified groups of assigned base stations comprises:
utilizing a balancing model to perform intra cluster balancing inside the technician clusters to generate the optimized technician assignments; and
generating the modified groups of assigned base stations based on the optimized technician assignments.

7. The method of claim 1, wherein generating the optimized technician assignments and the modified groups of assigned base stations comprises:
reassigning one or more base stations from one or more of the technicians to another one or more of the technicians based on workloads associated with the groups of assigned base stations; and
generating the optimized technician assignments and the modified groups of assigned base stations based on reassigning one or more base stations from one or more of the technicians to another one or more of the technicians.

8. A device, comprising:
one or more processors configured to:
receive map data identifying roads associated with geographical locations of technicians and base stations to be serviced by the technicians;
receive historical data identifying an average quantity of visits required for each of the base stations in a time period and an average quantity of time spent by the technicians at the base stations;
store the map data and the historical data in a data structure;
receive technician data identifying home geographical locations of the technicians and base station data identifying geographical locations of the base stations;
calculate travel distances and travel times between each of the technicians and each of the base stations based on the technician data, the base station data, and map data identifying roads associated with geographical locations of the technicians and the base stations;
calculate technician distances between the technicians based on the technician data;
determine one or more of the base stations to assign to each of the technicians, to generate groups of assigned base stations, based on processing the travel distances, the travel times, and the technician distances with a least cost model;
determine technician clusters based on processing the groups of assigned base stations with a clustering model;
generate optimized technician assignments and modified groups of assigned base stations based on performing intra cluster balancing inside the technician clusters; and
perform one or more actions based on the modified groups of assigned base stations.

9. The device of claim 8, wherein the one or more processors are further configured to:
generate further optimized technician assignments and further modified groups of assigned base stations based on performing inter cluster balancing of the optimized technician clusters.

10. The device of claim 8, wherein the one or more processors, to perform the one or more actions based on the modified groups of assigned base stations, are configured to one or more of:
provide data identifying the modified groups of assigned base stations for display; or
retrain one or more of the least cost model, the clustering model, or a balancing model based on the modified groups of assigned base stations.

11. The device of claim 8, wherein the one or more processors, to perform the one or more actions based on the modified groups of assigned base stations, are configured to:
assign, to the technicians, service tickets for servicing the base stations based on the modified groups of assigned base stations; and
monitor performance of the service tickets.

12. The device of claim 8, wherein the one or more processors, to perform the one or more actions based on the modified groups of assigned base stations, are configured to one or more of:
cause one of the technicians to relocate to a new home geographical location based on the modified groups of assigned base stations; or
add or remove one or more technicians, to or from the technicians, based on the modified groups of assigned base stations.

13. The device of claim 8, wherein the one or more processors, to perform the one or more actions based on the modified groups of assigned base stations, are configured to:
calculate a cost associated with the modified groups of assigned base stations; and
provide data identifying the cost for display.

14. The device of claim 8, wherein a balancing model performs intra cluster balancing inside the technician clusters by utilizing Euclidean distances and trigonometric models to generate the optimized technician assignments and the modified groups of assigned base stations.

15. A non-transitory computer-readable medium storing a set of instructions, the set of instructions comprising:
one or more instructions that, when executed by one or more processors of a device, cause the device to:
receive technician data identifying home geographical locations of technicians and base station data identifying geographical locations of base stations to be serviced by the technicians;
calculate travel distances and travel times between each of the technicians and each of the base stations based on the technician data, the base station data, and map data identifying roads associated with geographical locations of the technicians and the base stations;
calculate technician distances between the technicians based on the technician data;
determine one or more of the base stations to assign to each of the technicians, to generate groups of assigned base stations, based on processing the travel distances, the travel times, and the technician distances with a least cost model;
determine technician clusters based on processing the groups of assigned base stations with a clustering model;
generate optimized technician assignments and modified groups of assigned base stations based performing intra cluster balancing inside the technician clusters; and
perform one or more actions based on the modified groups of assigned base stations.

16. The non-transitory computer-readable medium of claim 15, wherein the one or more instructions, that cause the device to determine the one or more of the base stations to assign to each of the technicians, to generate the groups of assigned base stations, cause the device to:
calculate geographically nearest and least cost base stations, with respect to home locations of each of the technicians, based on the travel distances, the travel times, and the technician distances; and
assign the geographically nearest and least cost base stations to each of the technicians to generate the groups of assigned base stations,
wherein each group, of the groups of assigned base stations, is assigned to a corresponding one of the technicians.

17. The non-transitory computer-readable medium of claim 15, wherein the one or more instructions, that cause the device to determine the technician clusters based on processing the groups of assigned base stations with the clustering model, cause the device to:
identify next nearest technicians for each of the technicians based on the travel distances, the travel times, and the technician distances;
generating lists of next nearest technicians based on identifying next nearest technicians for each of the technicians; and
form the technician clusters based on the lists of next nearest technicians.

18. The non-transitory computer-readable medium of claim 15, wherein the one or more instructions, that cause the device to generate the optimized technician assignments and the modified groups of assigned base stations based performing intra cluster balancing inside the technician clusters, cause the device to:
utilize a balancing model to perform intra cluster balancing inside the technician clusters to generate the optimized technician assignments; and
generate the modified groups of assigned base stations based on the optimized technician assignments.

19. The non-transitory computer-readable medium of claim 15, wherein the one or more instructions, that cause the device to generate the optimized technician assignments and the modified groups of assigned base stations based on performing intra cluster balancing inside the technician clusters, cause the device to:
reassign one or more base stations from one or more of the technicians to another one or more of the technicians based on workloads associated with the groups of assigned base stations; and
generate the optimized technician assignments and the modified groups of assigned base stations based on reassigning one or more base stations from one or more of the technicians to another one or more of the technicians.

20. The non-transitory computer-readable medium of claim 15, wherein the one or more instructions further cause the device to:
generate further optimized technician assignments and further modified groups of assigned base stations based performing inter cluster balancing for optimized the technician assignments.
